(19) United States
(12) Patent Application Publication
(10) Pub. No.: US 2026/0339682 A1
(43) Pub. Date: Oct. 29, 2026

(54) BEHAVIOR LEARNING ON CRITICAL POWER SYSTEMS

(71) Applicant: ASCO Power Technologies, L.P., Florham Park, NJ (US)

(72) Inventor: Aditya RAWAL, Florham Park, NJ (US)

(21) Appl. No.: 19/191,366

(22) Filed: Apr. 28, 2025

(51) Int. Cl. G06F 9/451

(52) U.S. Cl. CPC G06F 9/451

(57) ABSTRACT

In a critical power system, data associated with previous user interactions is retrieved to determine whether the previous user interactions follow a recognized pattern. Based on the recognized pattern, a user interface for the critical power system automatically navigates to selected screens.

### BACKGROUND

In the changing world of energy, optimizing power reliability, energy costs, and operational efficiency, such as in critical power environments (e.g., hospitals, data centers, airports, and manufacturing facilities), is increasingly challenging. Utility power grids are becoming more dynamic and facility power distribution systems are becoming more complex and sensitive to power quality issues due to increasing electronic control devices. Such power quality issues threaten network stability. Competitive pressures and environmental regulations also push expectations for energy efficiency and business sustainability higher than ever.

Power quality issues are a primary cause of unexpected business downtime and equipment malfunction/damage/failure. Examples of the detrimental effects to equipment that may be attributed to power quality issues include overheating of equipment components (e.g., motors, capacitors, cables, transformers, etc.), accelerated wear and tear, premature aging of equipment components, malfunctions, and erroneous operations of circuit breakers, transfer switches, or relays.

The economic impact produced by power quality disturbances may include increased energy bills, financial penalties (e.g., penalties as a result of power disruption), and potentially detrimental impacts on the environment (e.g., increased carbon footprint). Power quality disturbances may also adversely result in increased charges related to demand, and increases in electrical/power system losses. Examples of areas influenced by power quality disturbances include: uptime, asset condition, and energy efficiency. For example, intentionally or even inadvertently removing electrical installations from service due to voltage sags, interruptions, and/or undervoltage/overvoltage conditions may affect uptime. Moreover, nuisance trips of circuits caused by harmonics, voltage swells, or transients may also lead to reduced uptime. Similarly, nuisance transfers of switches between sources may reduce uptime. Power quality disturbances or conditions may detrimentally affect assets such as cables, transformers, capacitor banks, etc. and energy efficiency. Moreover, power quality anomalies can result in overheating of equipment, unplanned changes in design characteristics, and/or decreased service life.

A power system installed in a critical power environment is considered a critical power system. Facility managers on the ground regularly check data points of the critical power system, including voltage, frequency, events, and/or alarms. They also regularly check the critical power system's settings via a human machine interface (HMI) either locally or via communications. These checks, which may be performed daily, weekly, or monthly, for example, are done to ensure the critical power system is working as intended and there are no errors or discrepancies in its functions. Often, a facility manager will follow a set routine for checking the critical power system at the same time of day each check (e.g., every Monday at 10:00 am).

While setting up a new critical power system, a new user of equipment is often unfamiliar with how to navigate to key functionality on the user interface (UI) of the system. If a wrong button is pressed on the UI, it could lead to unintended operation of the equipment in question. This inadvertent action could lead to a safety incident. For example, in transfer switches, if the facility manager mistakenly initiates transfer of the switch from utility to generator, the generator would be sent a start signal and turn on. If there are facility personnel working on the generator unaware of the start signal, a safety incident could result. A similar incident could take place not only during the setup of a new critical power system but also during the life of the equipment when the end user is looking for specific information from the UI. To make critical systems safer, a safe navigation feature is desired.

Addressing these challenges requires new tools designed specifically to enable faster response to opportunities and risks related to electrical/power system reliability and operational stability.

### SUMMARY

Aspects of the present disclosure provide automatic and/or user-configured navigation after learning user behavior by executing, for instance, a learning algorithm on a critical power HMI. Further aspects provide a user behavior learning algorithm in combination with along with user-configured preset navigation upon system “wake-up,” which leads to increased safety and decreased inadvertent action.

In an aspect, a method of operating a critical power system comprises retrieving, from a memory coupled to the critical power system, data associated with previous user interactions performed by a user of the critical power system. The method also includes analyzing the retrieved data to determine whether the previous user interactions follow a recognized pattern and, when the previous user interactions are determined to follow the recognized pattern, automatically navigating a UI of the critical power system according to the recognized pattern determined from the previous user interactions.

In another aspect, a computing system for operating a critical power system comprises a management processor and one or more memory devices coupled to the management processor. The memory devices store data associated with previous user interactions performed by a user of the critical power system and processor-executable instructions. When executed, the instructions configure the management processor for retrieving, from the memory devices, the data associated with the previous user interactions, analyzing the retrieved data to determine whether the previous user interactions follow a recognized pattern, and, when the previous user interactions are determined to follow the recognized pattern, automatically navigating a UI of the critical power system according to the recognized pattern determined from the previous user interactions.

In yet another aspect, one or more non-transitory computer-readable media have processor-executable instructions stored thereon. When executed by a management processor of a critical power system, the processor-executable instructions perform a method of operating the critical power system. The method includes retrieving, from a memory coupled to the critical power system, data associated with previous user interactions performed by a user of the critical power system. The method also includes analyzing the retrieved data to determine whether the previous user interactions follow a recognized pattern and, when the previous user interactions are determined to follow the recognized pattern, automatically navigating a UI of the critical power system according to the recognized pattern determined from the previous user interactions.

Other objects and features of the present invention will be in part apparent and in part pointed out herein.

### BRIEF DESCRIPTION OF THE DRAWINGS

FIG. 1 illustrates an example critical power system architecture according to an embodiment.

FIG. 2 is a block diagram illustrating an example computer system according to an embodiment.

FIG. 3 is a flow diagram illustrating an example process for executing behavior learning according to an embodiment.

FIG. 4 is a flow diagram illustrating an example process for executing system activity reporting according to an embodiment.

FIG. 5 is a flow diagram illustrating an example process for executing safe navigation to key functionality according to an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

Aspects of the present disclosure permit proper collection and interpretation of events, alarms, power quality data, and/or other associated data about a critical power system. Examples of such data include contextual data from a manufacturing process supervisory control and data acquisition (SCADA) system or a building management system (BMS), data associated with user interactions with the BMS system, user defined priority levels, etc. Collection and interpretation of this data may allow for both businesses and energy providers to discriminate useful information from collected events, improve electrical/power system operations, recovery time and efficiency, and limit detrimental effects from power quality disturbances and other undesirable conditions on the electrical/power system or facilities. Energy procurement managers may use power quality data to identify and avoid penalties or to revise/update energy contracts. Likewise, maintenance engineers may use power quality data to properly diagnose equipment issues and improve root cause analysis and reduce equipment downtime.

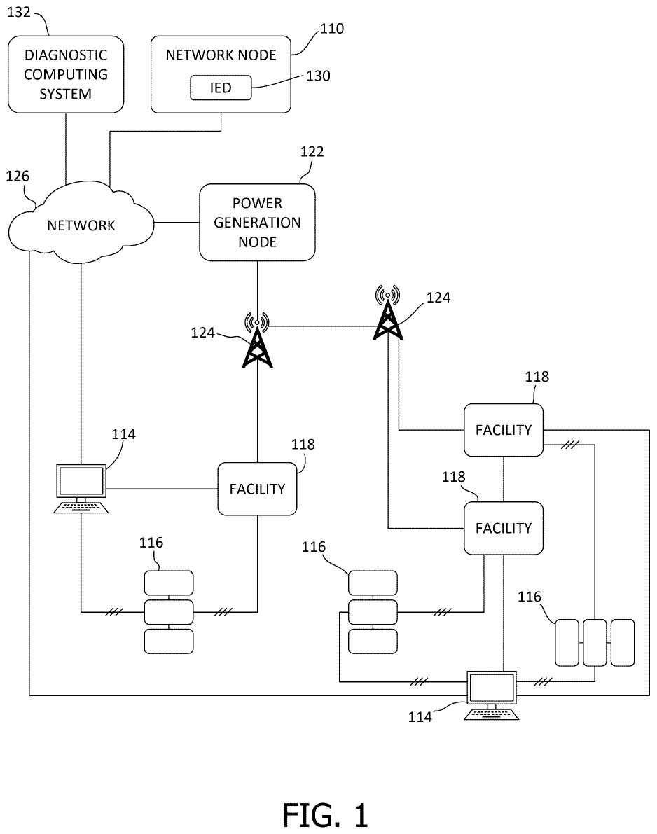

Referring to FIG. 1, a schematic view of an example critical power system architecture is depicted. According to one or more embodiments, the critical power system architecture is configured to perform among other things intelligent event and/or alarm analysis and management. The architecture includes an electrical or power monitoring and control system, referred to herein as an EPMS, including one or more network nodes 110 and user devices 114 to monitor and control equipment 116 or other devices of one or more facilities 118.

Herein, for simplicity, the term EPMS is also used to refer to a Monitoring and Control System (MCS), Power Monitoring System (PMS), or any other system that measures, derives, controls, and/or provides/reports information with respect to the electrical system. SCADA systems, BMSs, programmable logic controllers (PLCs), input/output systems and equipment, and/or any other system or combination of systems and/or devices capable of at least one of monitoring, measuring, deriving, gathering, processing, producing, analyzing, alarming, communicating, displaying, reporting, storing, and/or any other action and/or process associated with, or part of, a facility's utility system(s) (e.g., WAGES: water, air, gas, electricity, steam) may be considered relevant to this application. Additionally, a diagnostic system is used herein as a part or subset of the EPMS for identifying, analyzing, determining, ascertaining, learning, teaching, providing, benefiting, and/or otherwise evaluating data to obtain a better understanding of one or more data implication(s).

As shown in FIG. 1, the critical power system architecture also includes an electrical or power system to supply power from a power generation node(s) 122 to the facilities 118 across a power distribution network of a utility, e.g., power grids 124. The facilities 118 can be automated industrial facilities or include automated industrial equipment. The facilities 118 can also be commercial buildings, university campuses, or the like. The systems and devices in the critical power system architecture can use a local area network (LAN), wide area network (WAN), or internetwork (including the Internet) to communicate over a communication network 126. The communication network 126 can be a wired and/or wireless network that uses, for example, physical and/or wireless data links to carry network data among (or between) the network nodes.

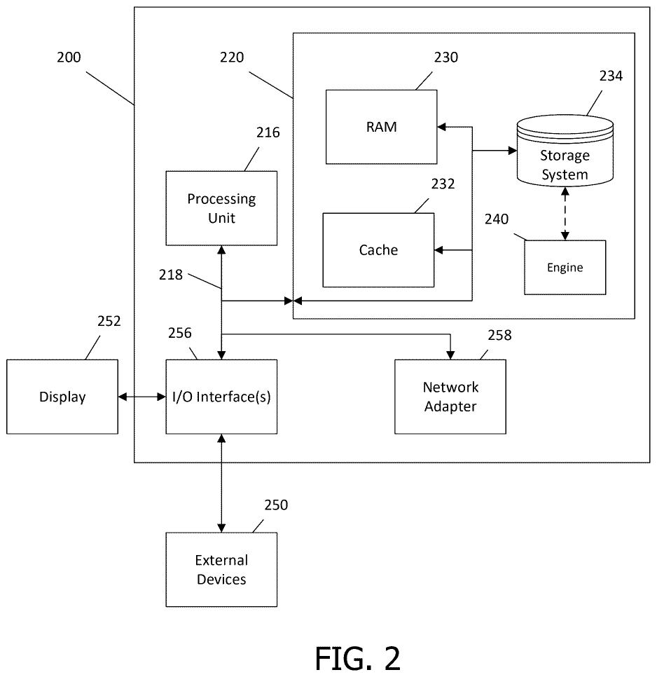

Each network node 110 can include a computer system (see FIG. 2). In an embodiment, the computer system comprises an intelligent electronic device (IED) 130, to sense, monitor, capture and analyze energy-related data on the electrical system related to the critical power system. In accordance with the various embodiments, the IED 130 can capture energy-related signal waveforms representative of voltage, current, power or other measurable electrical property on the electrical system, create power event profiles, perform event analysis to identify power events and additional information including alarms triggered in response to power events, and perform other operations as part of the systems and methods for managing smart alarms described herein. The IED 130 can be a smart device such as a smart power meter or other power equipment, or be incorporated into or associated with a power meter or other power equipment on the electrical system. The architecture can include a plurality of IEDs 130 arranged at different upstream and downstream positions in a hierarchical level or layer relationship on the electrical system to monitor, derive or calculate, analyze and share energy-related information (e.g., measurement data, derived data, event data and additional information, results of event analysis, event profiles, etc.) at any desired position along the electrical system, including positions along the grid, between the utility and a facility, and within the facility. Each of the IEDs 130 may be installed at a respective metering point or location of a plurality of metering points or locations in the electrical system.

In some embodiments, a user may view information about the IEDs 130 (e.g., IED make, model, type, etc.) and data collected by the IEDs 130 (e.g., energy usage statistics) using at least one of the user devices 114. Additionally, in some embodiments the user may configure the IEDs 130 using at least one of the user devices 114. Each user device 114 can include a computing device, for example, a desktop computer, a laptop computer, a handheld computer, a tablet computer, a smart phone, and/or the like. Additionally, each user device 114 can include or be coupled to one or more input/output devices, for example, to facilitate user interaction with the IEDs 130 (e.g., to view information about the IEDs 130).

In some embodiments, the EPMS may also include, or be communicatively coupled to, a diagnostic system 132 via the communication network 126. In some embodiments, the above-discussed IEDs 130 and user devices 114 of the EPMS may be directly communicatively coupled to the diagnostic system 132. In other embodiments, the IEDs 130 and user devices 114 may be indirectly communicatively coupled to the diagnostic system 132, for example, through an intermediate device, such as a cloud connected hub or a gateway. The cloud-connected hub (or the gateway) may, for example, provide the IEDs 130 and the user devices 114 with access to the diagnostic system 132. In an embodiment, the EPMS comprises at least one IED 130 configured to provide energy-related signals relating to the critical power system.

The diagnostic system 132 may be an example of a cloud computing system, or cloud-connected computing system. In embodiments, the diagnostic system 132 may be a server located within one or more of the facilities 118, or may be a remotely-located cloud-based service. The diagnostic system 132 may include computing functional components similar to those of the IEDs 130 is some embodiments, but may generally possess greater quantities and/or more powerful versions of components involved in data processing, such as processors, memory, storage, interconnection mechanisms, etc. The diagnostic system 132 can be configured to implement a variety of analysis techniques to identify patterns in received measurement data from the IEDs 130, as discussed further below. The various analysis techniques discussed herein further involve the execution of one or more software functions, algorithms, instructions, applications, and parameters, which are stored on one or more sources of memory communicatively coupled to the diagnostic system 132.

In certain embodiments, the terms “function”, “algorithm”, “instruction”, “application”, or “parameter” may also refer to a hierarchy of functions, algorithms, instructions, applications, or parameters, respectively, operating in parallel and/or tandem. A hierarchy may comprise a tree-based hierarchy, such a binary tree, a tree having one or more child nodes descending from each parent node, or combinations thereof, wherein each node represents a specific function, algorithm, instruction, application, or parameter.

In embodiments, since the diagnostic system 132 is connected to the cloud, it may access additional cloud-connected devices or databases (not shown) via the cloud. For example, the diagnostic system 132 may access historical measurement data previously received from the at least one IED 130, historical power event and/or alarm data, or other data that may be useful in analyzing current measurement data received from the at least one IED 130. In embodiments, the cloud-connected devices or databases may correspond to a device or database associated with one or more external data sources.

In embodiments, by leveraging the cloud-connectivity and enhanced computing resources of the diagnostic system 132 relative to the IEDs 130, sophisticated analysis can be performed on data retrieved from one or more IEDs 130, as well as on additional sources of data that may be received (e.g., from other devices in the electrical system, such as humidity and temperature sensors), when appropriate. This analysis can be used to dynamically control one or more parameters, processes, conditions or devices (e.g., equipment 116) associated with the electrical system.

In embodiments, the parameters, processes, conditions or equipment are dynamically controlled by one or more control devices of the EPMS. In embodiments, the control devices may correspond to, include, or be included in one or more of the above-discussed IEDs 130, diagnostic system and/or other devices within or external to the electrical system.

It is understood that the network architecture shown in FIG. 1 is but one example network architecture of many potential network architectures that may be suitable for the systems and methods described herein. Any suitable network architecture may be used, which allows for communication and interaction between components of the EPMS (e.g., IEDs 130, diagnostic system, user devices, etc.), equipment or loads, facilities, etc. to perform the operations described herein. For example, the systems and methods herein, including but not limited to the identification of events (e.g., power events), and/or the identification of alarms triggered in response to the events, can be implemented through a cloud-based architecture via one or more network nodes. In one or more embodiments, operations described herein may be implemented using a computer system such as shown and described in FIG. 2.

Commonly assigned U.S. Pat. No. 12,131,625, the entire disclosure of which is incorporated herein by reference, discloses an example configuration (e.g., a hierarchical configuration) of IEDs 130 in an electrical system. Such an electrical system typically includes one or more metering points or locations and one or more IEDs 130 may be installed or located (temporarily or permanently) at the metering locations, for example, to measure, protect and/or control a load or loads in the electrical system. In some instances, the IEDs 130 may be part of or associated with an EPMS. The EPMS may be responsible for monitoring and/or controlling the electrical system, for example. The above-described IEDs 130 can record an electrical event's voltage and current phase information (e.g., by sampling the respective signals) and communicatively transmit this information to a diagnostic system (e.g., 132, shown in FIG. 1). The EPMS may then analyze the voltage and current phase information (e.g., instantaneous, root-mean-square (rms), waveforms and/or other electrical characteristics) to determine if the source of the voltage event was electrically upstream or downstream from where the first and/or second IEDs 130 are electrically coupled to the electrical system (or network), for example, to determine a direction of a power event (i.e., upstream or downstream).

Monitoring and maintenance of critical power systems are essential to ensuring that the systems work without interruption and as intended. Once a critical power system is installed, facility managers on the ground typically check data points such as voltage, frequency, events, and alarms as well as system settings via the human machine interface (HMI) associated with the critical power system. In an embodiment, user device 114 of FIG. 1 comprises an HMI. The HMI may be accessed locally or via communications on a regular basis (e.g., daily, weekly, monthly). These checks are done to ensure the critical power system is working as intended and there are no errors or discrepancies in the system function. In practice, a facility manager or the like usually performs these checks at the same time, every time. That is, the facility manager will follow a set routine (e.g., performing a check every Monday at 10:00 am). Specifically, the facility manager wants to know if there have been any changes on the system since the last review of the system.

A computer system 200 is shown in FIG. 2 in the form of a general-purpose computing device. The components of the computer system 200 may include, but are not limited to, one or more processors or processing units 216, a bus 218, and a system memory 220. In the illustrated embodiment, the bus 218 couples various system components, including the system memory 220, to the processor 216. In one or more embodiments, user device 114 comprises computer system 200 for performing the operations described herein. It is to be understood that in one or more other embodiments, diagnostic computing system 132 or equipment 116 comprises computer system 200 for performing the operations described herein.

The bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

According to one or more embodiments, computer system 200 typically includes a variety of computer-readable media. Such media may be any available media that is accessible by computer system 200, and it includes both volatile and non-volatile media, removable and non-removable media.

The system memory 220 can include computer-readable media in the form of volatile memory, such as random-access memory (RAM) 230 and/or cache memory 232. The computer system 200 may further include other removable/non-removable, volatile/non-volatile computer system storage media. By way of example only, a storage system 234 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 220 may include at least one program product having a set (e.g., at least one) of program modules that are configured to carry out the functions of embodiments of the disclosure.

To optimize this experience, aspects of the present disclosure provide a Behavior Learning Algorithm, which in one or more embodiments, may be executed on a computer system such as shown and described in FIG. 2. In an embodiment memory 220 comprises a firmware and/or software engine 240. The user device 114, or comparable computing device or system, executes the engine 240, which is configured to identify the repetitive behavior(s) of the user and automatically navigate to the correct screen/menu and/or automatically perform a function when the user begins interacting with the system. In an embodiment, engine 240 comprises a rules-based engine. In another embodiment, engine 240 comprises an artificial intelligence (AI) engine configured to learn from the repetitive behavior(s) of the user.

For example, automatically navigating the UI comprises displaying a selected screen or a series of selected screens on the UI to present information expected to be associated with the recognized pattern to the user. This expected information may include a particular data point, menu, list of active alerts or alarms, etc. that are displayed on the screen(s) repeatedly accessed by the user according to the recognized pattern of repetitive behavior(s). When displaying a series of selected screens on the UI, each of the selected screens presents information expected to be associated with the recognized pattern for a predetermined amount of time. According to one or more embodiments, automatically performing a selected function includes performing the function expected to be associated with the recognized pattern, such as a function typically associated with the screen(s) repeatedly accessed by the user according to the recognized pattern of repetitive behavior(s). In an embodiment, automatically navigating to the selected screen comprises automatically performing a selected function, wherein the selected function is expected to be associated with the identified system activity.

In an embodiment, the learning algorithm takes into account the number of times the user has been to a particular UI screen over time (e.g., day, week, or month) and for what length of time. After learning the behavior, the learning algorithm stores the data and provides the user with the option to ‘auto-navigate’. A recognized pattern of repetitive behavior(s) is in essence based on the number of times the user has been on a screen in combination with the time spent on the screen itself. Advantageously, aspects of the present disclosure leverage data such as time spent on particular screen as well as frequency of user going to check a particular data point/menu.

The computer system 200 may also communicate with one or more external devices 250 such as a keyboard, a pointing device, a display 252, etc.; one or more devices that enable a user to interact with computer system 200; and/or any devices (e.g., network card, modem, etc.) that enable computer system 200 to communicate with one or more other computing devices. Such communication can occur via Input/Output (I/O) interfaces 256. Still yet, computer system 200 can communicate with one or more networks such as a LAN, a general WAN, and/or a public network (e.g., the Internet) via a network adapter 258. As depicted, the network adapter 258 communicates with the other components of a network (not shown) via bus 218. It should be understood that although not shown, other hardware and/or software components could be used in conjunction with computer system 200. Examples include, but are not limited to: microcode, device drivers, redundant processing units, external disk drive arrays, RAID systems, tape drives, and data archival storage systems, and so on.

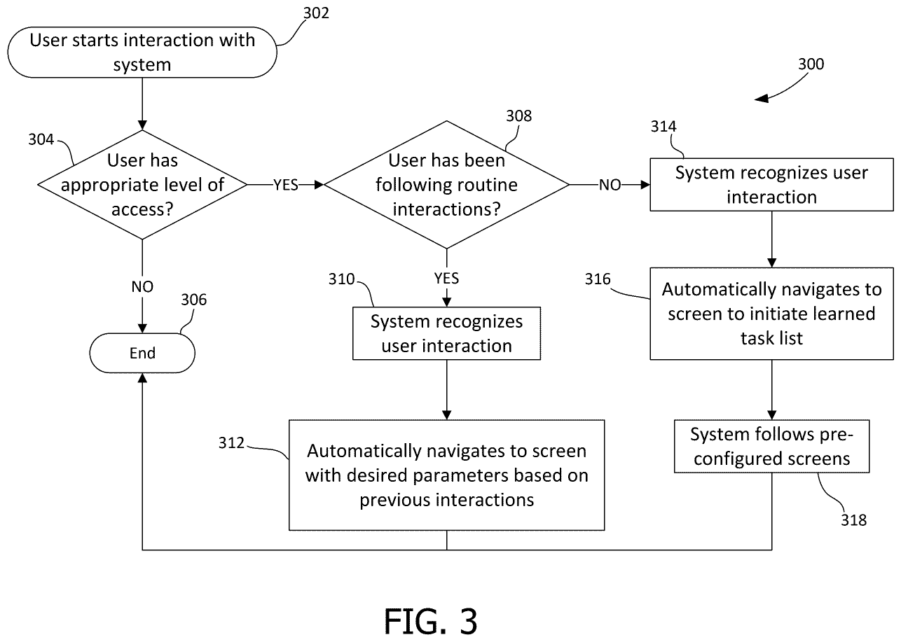

Referring now to FIG. 3, an example process 300 embodying aspects of the present disclosure for learning and optimizing user behavior begins at 302 when a user interacts with the critical power system. In operation, processor 216 determines at 304 whether the user has an appropriate level of access for performing a system check. For instance, processor 216 receives authentication credentials from the user of the critical power system and authenticates the user based on the credentials. If the user cannot be authenticated, processor 216 denies the user access to the system and the process 300 ends at 306. On the other hand, if the user is authorized to check the status of the critical power system, processor 216 permits user interactions with the critical power system in accordance with a level of access associated with the user based on the authentication. Once the user is authenticated, operations proceed to 308 for determining whether the user has been following routine interactions with the system. To make this determination, processor 216 retrieves data from the memory 220. According to one or more embodiments, processor 216 and memory 220 are coupled to the critical power system such that the retrieved data is preferably associated with previous user interactions by the user while checking the critical power system. If the user has been following routine interactions, processor 216 executes the Behavior Learning Algorithm of engine 240 at 310 to recognize the user interaction and determine from the retrieved data whether the user interaction follows a recognized pattern. At 312, processor 216 automatically navigates a UI of the critical power system according to the pattern determined from the previous user interactions to facilitate the recognized user interaction. In an embodiment, this functionality is automatic. In another embodiment, this functionality is configurable by the user.

In the event the processor 216 determines at 308 that the user has not been following routine interactions with the system, processor 216 first recognizes at 314 what user interaction is taking place and then automatically navigates a UI of the critical power system at 316 to initiate a predefined learned task list associated with the recognize user interaction. The processor 216 causes the UI to present one or more pre-configured screens at 318 to assist the user in performing the system check. In an embodiment, automatically navigating the UI of the critical power system to the one or more pre-configured screens is done according to a learning mode when the previous user interactions do not follow a recognized pattern. In the embodiment of FIG. 3, processor 216 embodies a management processor configured to perform the operations described herein.

In critical power systems, safety is most important. By having an automatic learning algorithm/user configured routine, aspects of the present disclosure reduce the number of touch-points the user must make to view critical data or perform a function. This functionality reduces the chance of error and thus improves safety of the system. Advantageously, aspects of the present disclosure provide automatic navigation after learning of customer behaviors (utilizing, for example, the Behavior Learning Algorithm) on a critical power HMI and/or user-configured navigation on the critical power HMI. The Behavior Learning Algorithm in accordance with one or more embodiments in combination with permitting users with the opportunity to configure a pre-set navigation upon system “wake-up” leads to increased safety and decreased inadvertent action. These are key pillars in the critical power market space.

The following are example use cases embodying aspects of the present disclosure:

### Monitor Voltage and Frequency

External Actors—User with access to the critical power system.
System Actors—HMI (local or via communication) on the critical power system
Pre-Conditions—User has the appropriate level of access to the system; User has been following routine and interacting with the system to find voltage and frequency data points at set times.
Trigger—User starts interaction with the system.
Steps:
   i. User starts interaction with the system.
   ii. System recognizes user interaction and automatically navigates to the screen with voltage and frequency.
   iii. User takes a note of all the information.
Post-Condition—User has voltage and frequency information in an efficient manner; User can navigate away from the screen and to do other functions.
Exceptions—User has option to cancel “automatic navigation” and selects “configured” walk through instead.

### Completion of Multiple Tasks

External Actors—User with access to the critical power system.
System Actors—HMI (local or via communication) on the critical power system
Pre-Conditions—User has the appropriate level of access to the system; User has been following routine and interacting with the system to find voltage and frequency data points at set times.
Trigger—User starts interaction with the system.
Steps:
   i. User starts interaction with the system.
   ii. System recognizes user interaction and automatically navigates to the screen for the user to initiate learned task list.
   iii. User takes a note of all the information.
Post-Condition—User has completed all their tasks in an efficient manner; User can navigate away from the screen and to do other functions.
Exceptions—User has option to cancel “automatic navigation.”

As shown by the use cases, behavior learning algorithms in critical power systems can lead to less user error and more safety. Additionally, this functionality helps increase the time efficiency of the users.

Improved system activity reporting functionality in accordance with one or more embodiments helps the facility manager by providing a report of system activity that has occurred since the user's last login. The system report also uses the data points in the reports to provide the user with recommended actions to address the critical power system's present, or current, activity. For example, if there is a “Processor Alarm” that was activated since the last login, aspects of the present disclosure provide a recommended action of calling the services team. Such reporting may also provide the user with the system data points and/or information over time to assist the user in assessing the overall health of the system.

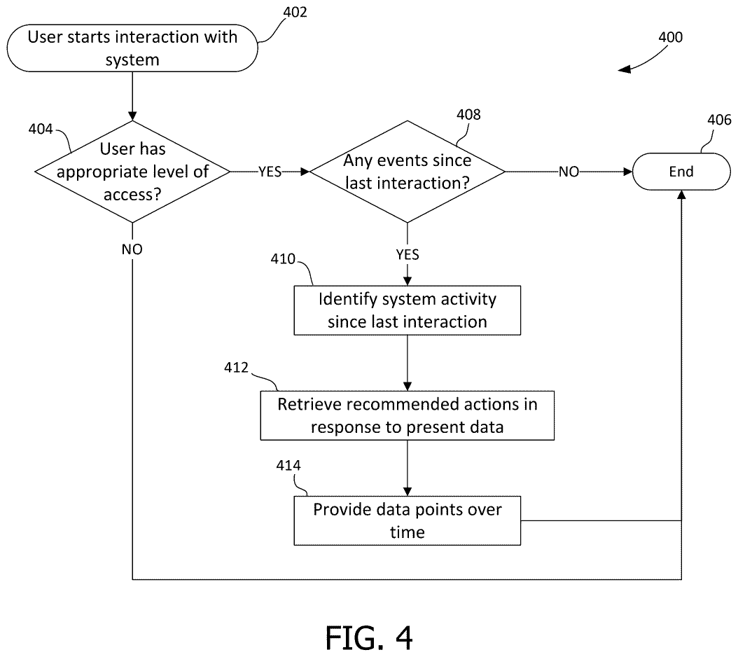

Referring now to FIG. 4, an example process 400 embodying aspects of the present disclosure for executing system activity reporting begins at 402 when a user interacts with the system. In operation, processor 216 determines at 404 whether the user has an appropriate level of access for performing a system check. For instance, processor 216 receives authentication credentials from the user of the critical power system and authenticates the user based on the credentials. If the user cannot be authenticated, processor 216 denies the user access to the system and the process 400 ends at 406. On the other hand, if the user is authorized to check the status of the critical power system, processor 216 permits user interactions with the critical power system in accordance with a level of access associated with the user based on the authentication.

Once the user is authenticated, operations proceed to 408 for determining whether there have been any events since the user's last interaction with the system. System activity comprises, for example, one or more of alarms or events. If there have been no new events since the previous interaction, the process 400 ends at 406. To make this determination, processor 216 retrieves data from memory 220. According to one or more embodiments, processor 216 and memory 220 are coupled to the critical power system such that the retrieved data is preferably associated with previous user interactions by the user while checking the critical power system. If there have been any new events with the system, processor 216 executes processor-executable instructions at 410 to identify what system activity has occurred since the user's last interaction and, at 412, retrieve from memory 220 any predetermined recommended actions in response to the present system activity data. In an embodiment, processor 216 executes engine 240 at 412 to generate recommended actions in response to the present system data. At 414, process 400 preferably causes data associated with system activity over time to be displayed on a UI of display 252 of the critical power system for use in assessing health of the critical power system. In an embodiment, only the system activity occurring since the previous user interaction is displayed. In the embodiment of FIG. 4, processor 216 embodies a management processor configured to perform the operations described herein.

The system reporting functionality includes, for example, providing system activity since the user's last login such that the user can be readily informed of present activity on the system without having to navigate to multiple screens. This functionality also permits, for example, providing recommended actions based on the data especially in alarm conditions; and providing data points over time to judge health of system. The data-over-time may be displayed in the form of a graph in combination with set points or thresholds at which maintenance is recommended to maintain health of the system. In this manner, aspects of the present disclosure promote improved safety and reliability of the system.

While setting up a new critical power system, a new user of equipment is often unfamiliar with how to navigate to key functionality on the UI of the system. If a wrong button is pressed on the UI, it could lead to unintended operation of the equipment in question. This inadvertent action could lead to an undesired safety incident. For example, in an embodiment in which equipment 116 comprises a transfer switch, if the facility manager mistakenly initiates transfer of the switch from utility to generator, the generator would be sent a start signal causing it to turn on. If facility personnel happen to be working on the generator when it turns on, serious safety concerns could result. Such an incident could also occur not only during the setup of a new system but also during the life of the equipment when the user interacts with the UI while searching for system information.

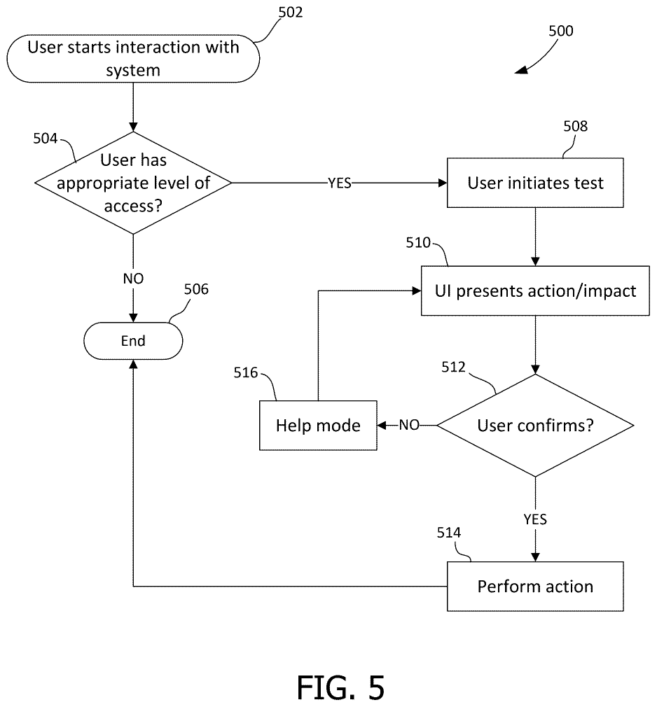

Referring now to FIG. 5, an example process 500 embodying aspects of the present disclosure for executing safe navigation to key functionality begins at 502 when a user interacts with the system. In operation, processor 216 determines at 504 whether the user has an appropriate level of access for performing a system check. For instance, processor 216 receives authentication credentials from the user of the critical power system and authenticates the user based on the credentials. If the user cannot be authenticated, processor 216 denies the user access to the system and the process 500 ends at 506. On the other hand, if the user is authorized to check the status of the critical power system, processor 216 permits user interactions with the critical power system in accordance with a level of access associated with the user based on the authentication.

Once the user is authenticated, operations proceed to 508 at which point the user is permitted to initiate a test function. At 510, process 500 causes a UI on display 252 to present actions and/or impacts of the designated test function. To determine such actions and/or impacts, processor 216 retrieves data from memory 220. According to one or more embodiments, processor 216 and memory 220 are coupled to the critical power system such that the retrieved data is preferably associated with previous user interactions by the user while performing tests on the critical power system. In an embodiment, processor 216 executes engine 240 at 510 to generate predicted actions and/or impacts responsive to initiating the test. By enabling a “learn” mode in this manner, the UI presents a comprehensive list of actions to be performed during the test and explains their respective impacts before the user commences the test. Proceeding to 512, process 500 requires confirmation from the user before executing the test actions at 514 in response to the user input (e.g., initiating the test function via the UI).

In the event the user does not confirm the test, operations continue at 516 to a help mode in response to user input to provide additional information or alternative actions. By enabling a “help” mode in this manner, the user is afforded an opportunity to better understand, for example, where to locate certain functionality. The name of the function may be entered into a search field of the UI, which in turn provides a navigation path to the functionality. For example, if the user types in “timers” as the user input, the system responds with the following navigation: main screen->setting screen->features->timers. Moreover, in accordance with one or more embodiments, the UI presented on display 252 provides the option to click a button in a help window to navigate directly to the function. In the above example, if the user types in “timers” as the user input, a “click here to navigate to timers” button is also available to the user for providing additional user input. Once clicked, the user is taken to the correct screen for timers. Aspects of the present disclosure further provide for a firmware upgradable database of feature/function names along with other commonly called names to be saved by the system for “learn” mode and “help” mode. Aspects provide increased safety by reduction of inadvertent operation of the system and better training, which leads to greater user satisfaction. In the embodiment of FIG. 5, processor 216 embodies a management processor configured to perform the operations described herein.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored in memory, i.e., one or more tangible, non-transitory storage media, and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A method of operating a critical power system, the method comprising:
retrieving, from a memory coupled to the critical power system, data associated with previous user interactions performed by a user of the critical power system;
analyzing the retrieved data to determine whether the previous user interactions follow a recognized pattern; and
when the previous user interactions are determined to follow the recognized pattern, automatically navigating a user interface of the critical power system according to the recognized pattern determined from the previous user interactions.

2. The method of claim 1, further comprising automatically navigating the user interface of the critical power system to one or more predetermined screens according to a learning mode when the previous user interactions are determined to not follow the recognized pattern.

3. The method of claim 1, further comprising:
receiving authentication credentials from the user of the critical power system and authenticating the user based thereon; and
permitting user interactions with the critical power system in accordance with a level of access associated with the user based on the authentication.

4. The method of claim 1, further comprising executing an engine configured to identify the recognized pattern determined from the previous user interactions.

5. The method of claim 4, wherein automatically navigating the user interface comprises displaying a selected screen on the user interface, wherein the selected screen presents information expected to be associated with the recognized pattern.

6. The method of claim 4, wherein automatically navigating the user interface comprises automatically performing a selected function, wherein the selected function is expected to be associated with the recognized pattern.

7. The method of claim 4, wherein automatically navigating the user interface comprises displaying a series of selected screens on the user interface, wherein each of the selected screens presents information expected to be associated with the recognized pattern for a predetermined amount of time.

8. The method of claim 1, further comprising processing data associated with the critical power system to identify one or more of events or alarms triggered in response to the events.

9. The method of claim 8, further comprising receiving the data associated with the critical power system from at least one of an Electrical Power Monitoring System (EPMS), a SCADA system, a building management system (BMS), I/O devices, Programmable Logic Controller (PLC) data, or system users.

10. A computing system for operating a critical power system, the computing system comprising:
a management processor;
one or more memory devices coupled to the management processor, the one or more memory devices storing data associated with previous user interactions performed by a user of the critical power system and processor-executable instructions that, when executed, configure the management processor for:
retrieving, from the one or more memory devices, the data associated with the previous user interactions;
analyzing the retrieved data to determine whether the previous user interactions follow a recognized pattern; and
when the previous user interactions are determined to follow the recognized pattern, automatically navigating a user interface of the critical power system according to the recognized pattern determined from the previous user interactions.

11. The computing system of claim 10, further comprising a display coupled to the management processor, and wherein automatically navigating the user interface comprises presenting one or more predetermined screens on the display according to a learning mode when the previous user interactions are determined to not follow the recognized pattern.

12. The computing system of claim 10, wherein the one or more memory devices store processor-executable instructions that, when executed, further configure the management processor for:
receiving authentication credentials from the user of the critical power system and authenticating the user based thereon; and
permitting user interactions with the critical power system in accordance with a level of access associated with the user based on the authentication.

13. The computing system of claim 10, wherein the processor-executable instructions stored in the one or more memory devices comprise an engine configured to identify the recognized pattern determined from the previous user interactions.

14. The computing system of claim 13, wherein the one or more memory devices store processor-executable instructions that, when executed, further configure the management processor for displaying a selected screen on the user interface to automatically navigate the user interface, and wherein the selected screen presents information expected to be associated with the recognized pattern.

15. The computing system of claim 13, wherein the one or more memory devices store processor-executable instructions that, when executed, further configure the management processor for automatically performing a selected function, wherein the selected function is expected to be associated with the recognized pattern.

16. The computing system of claim 13, wherein the one or more memory devices store processor-executable instructions that, when executed, further configure the management processor for displaying a series of selected screens on the user interface to automatically navigate the user interface, wherein each of the selected screens presents information expected to be associated with the recognized pattern for a predetermined amount of time.

17. The computing system of claim 10, wherein the one or more memory devices store processor-executable instructions that, when executed, further configure the management processor for processing data associated with the critical power system to identify one or more of events or alarms triggered in response to the events.

18. The computing system of claim 17, wherein the data associated with the critical power system is obtained from at least one of an Electrical Power Monitoring System (EPMS), a SCADA system, a building management system (BMS), I/O devices, Programmable Logic Controller (PLC) data, or system users.

19. The computing system of claim 18, wherein the EPMS comprises at least one intelligent electronic device (IED) configured to provide energy-related signals relating to the critical power system.

20. One or more non-transitory computer-readable media having processor-executable instructions stored thereon, the processor-executable instructions, when executed by a management processor of a critical power system, perform a method of operating the critical power system comprising:
retrieving, from a memory coupled to the critical power system, data associated with previous user interactions performed by a user of the critical power system;
analyzing the retrieved data to determine whether the previous user interactions follow a recognized pattern; and
when the previous user interactions are determined to follow the recognized pattern, automatically navigating a user interface of the critical power system according to the recognized pattern determined from the previous user interactions.
